(19) United States
(12) Patent Application Publication
(10) Pub. No.: US 2007/0132411 A1
(43) Pub. Date: Jun. 14, 2007

(54) Multi-stage contactless switch

(75) Inventors: Volker Stegmann, Aschaffenburg (DE); Michael Roeder, Sinntal (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/605,104

(22) Filed: Nov. 28, 2006

(30) Foreign Application Priority Data
Dec. 9, 2005 (DE) 20 2005 019 271.6

(51) Int. Cl. H02P 7/06

(52) U.S. Cl. 318/254

(57) ABSTRACT

A multi-stage contactless switch, in particular for an operating element in a motor vehicle, has a movably arranged magnet and several Hall sensor elements spaced apart from each other. Each Hall sensor element is capable of activating a particular switching state depending on a magnetic field of the magnet as detected by the Hall sensor.

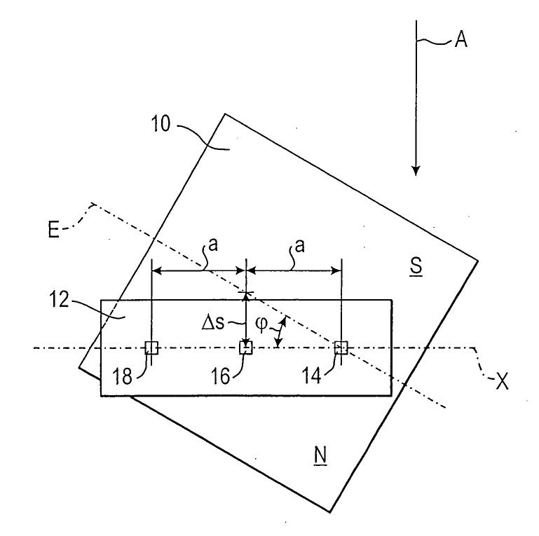

### TECHNICAL FIELD

The invention relates to a multi-stage contactless switch, in particular for an operating element in a motor vehicle.

### BACKGROUND OF THE INVENTION

Multi-stage operating elements in motor vehicles are often realized by several microswitches which are arranged adjacent to each other. In addition to requiring a comparatively large amount of space and the costly mechanical construction, such operating elements have the disadvantage that they are prone to wear, because the electric contacts are produced by physical contact of contact elements.

Contactless switches based on the Hall effect are generally known. An example of such a switch with two switching states is shown in U.S. Pat. No. 4,061,988. A permanent magnet which is fastened to a pin is linearly displaceable, the permanent magnet being able to be moved from an initial position into a position directly adjacent to a Hall effect sensor switching circuit. The switching circuit responds to the change in the magnetic field and thereby initiates a switching process. A multi-stage operating element based on such a switch type would, however, again require several switches.

It is an object of the invention to provide a switching device which saves as much space as possible, has a long lifespan, and enables a multi-stage operation in a comfortable manner.

### BRIEF SUMMARY OF THE INVENTION

According to the invention, a multi-stage contactless switch has a movably arranged magnet and several Hall sensor elements spaced apart from each other. Each Hall sensor element is capable of activating a particular switching state depending on a magnetic field of the magnet as detected by the Hall sensor. The invention is based on the finding that the design of a two-stage switch based on the Hall effect is able to be expanded to several switching states by a suitable construction of the switch. Contactless switching processes, which are free of wear, are possible in several stages with the switch according to the invention, without requiring an enlarged operating field for this. As no physical contacts of contact elements have to be taken into account, the mechanical realization of the switching paths and switching points can be largely freely arranged, so that a comfortable operation can be realized, having a pleasant “feel”. The bounce-free switch is therefore suitable for applications in high quality motor vehicles, such as for example for actuating a direct switching gear via an operating element which is arranged on the steering wheel of the vehicle.

### BRIEF DESCRIPTION OF THE DRAWING

In the drawing, the single FIGURE shows diagrammatically the essential elements of a switch according to the invention.

### DETAILED DESCRIPTION OF THE PREFERRED EMBODIMENTS

The two-dimensional illustration of the FIGURE is restricted to the essential electrical and magnetic components of a multi-stage contactless switch. The mechanical components of the switch will be described after the description of the function.

A parallelepiped-shaped permanent magnet 10 has an equatorial plane E which separates the north pole N from the south pole S of the permanent magnet 10. The permanent magnet 10 is linearly movable in the direction of the arrow A and back.

A bipolar Hall IC switching component 12 contains several (three in the example shown) Hall sensor elements 14, 16, 18, which define a sensor axis X. The Hall sensor elements 14, 16, 18 are arranged at the same distance a on the sensor axis X. The Hall IC component 12 is arranged so that the permanent magnet 10 is guided past in the immediate vicinity (behind the component 12 in the FIGURE), so that it is ensured that the Hall sensor elements 14, 16, 18 respond reliably and in a defined manner to a change in magnetic field brought about by the movement of the permanent magnet 10.

The direction of movement of the permanent magnet 10 runs perpendicularly to the sensor axis X of the Hall IC component. The relative orientation of the Hall IC component to the permanent magnet 10 is selected such that the sensor axis X is tilted by an acute angle φ with respect to the equatorial plane E of the permanent magnet 10.

The mode of operation of the multi-stage switch is explained below. The permanent magnet 10 is moved from an initial position in the direction of the arrow A. Ideally, the first Hall sensor element 14 responds precisely when the equatorial plane E of the permanent magnet 10 passes the element, and then activates a first switching process (first switching state). This situation corresponds to the illustration in the FIGURE, which shows the first Hall sensor element 14 precisely on the equatorial plane E.

Proceeding from this state, a further linear movement of the permanent magnet 10 in the direction of the arrow A by the distance Δs (switching path) is necessary, until the second Hall sensor element 16 responds and activates a second switching process (second switching state). This distance Δs can be calculated by means of simple geometric considerations from the distance a of the two Hall sensor elements 14 and 16 and also the angle φ between the sensor axis X and the equatorial plane E:
Δs=a·tan φ

The same applies to the switching path for reaching the third switching state and to further switching paths in the case of additional Hall sensor elements.

Vice versa, this means that in accordance with the basic structure of the multi-stage switch shown in the FIGURE, the switching path between two switching states can be prescribed by the distance a between the Hall sensor elements 14, 16, 18 and the angle φ between the sensor axis X and the equatorial plane E. Of course, different distances of the Hall sensor elements 14, 16, 18 and therefore switching paths of different lengths are also possible.

The mechanical realization of the switching paths and switching points may take place for example by means of a suitable connecting link, in which a detent position is provided which is associated with the initial position of the permanent magnet 10 and each switching point.

Instead of a parallelepiped-shaped permanent magnet 10, a different magnet shape may also be used, e.g. a cylindrical rod magnet, or a different type of magnet.

The use of the multi-stage contactless switch according to the invention is not restricted to the operation of a direct switching gear or other operating elements in a motor vehicle. Rather, the advantageous switch may be used generally in the field of household applications and in industry.

1. A multi-stage contactless switch, in particular for an operating element in a motor vehicle, the switch having a movably arranged magnet and several Hall sensor elements spaced apart from each other, each Hall sensor element being capable of activating a particular switching state, depending on a magnetic field of the magnet as detected by the Hall sensor.

2. The switch according to claim 1, wherein the Hall sensor elements are housed in an IC component.

3. The switch according to claim 1, wherein the Hall sensor elements define a sensor axis which is tilted with respect to an equatorial plane of the magnet.

4. The switch according to claim 3, wherein the Hall sensor elements are arranged at equal distances on the sensor axis X.

5. The switch according to claim 3, wherein the Hall sensor elements are arranged at unequal distances on the sensor axis X.

6. The switch according to claim 3, wherein the magnet has a given direction of movement which runs perpendicularly to the sensor axis.

7. The switch according to claim 1, wherein a connecting link is provided, which defines several detent positions of the magnet.

8. The switch according to claim 7, wherein the number of detent positions is equal to or greater than the number of Hall sensor elements.
